(19) United States
(12) Patent Application Publication
(10) Pub. No.: US 2014/0347579 A1
(43) Pub. Date: Nov. 27, 2014

(54) ELECTRODE PATTERN OF TOUCH PANEL AND METHOD OF MANUFACTURING THE SAME

(71) Applicant: LG INNOTEK CO., LTD., Seoul (KR)

(72) Inventors: Jae Joon Jang, Seoul (KR); Hyuk Jin Hong, Seoul (KR); Ji Won Jo, Seoul (KR)

(21) Appl. No.: 14/359,812

(22) PCT Filed: Nov. 30, 2012
(86) PCT No.: PCT/KR2012/010270

§ 371 Date: May 21, 2014

(30) Foreign Application Priority Data
Dec. 8, 2011 (KR) 10-2011-0130646

(51) Int. Cl. G06F 3/044

(52) U.S. Cl. CPC G06F 3/044; G06F 2203/04111
USPC 349/12

(57) ABSTRACT

Provided is an electrode panel of a touch panel and a method of manufacturing the same, the method, including: forming a plurality of electrode pattern cells on a substrate to be space apart from each other; forming an insulating layer on the electrode pattern cells; forming a hole on the insulating layer; and forming a bridge electrode and fills the hole with a conductive material.

### TECHNICAL FIELD

The present invention relates to an electrode pattern of a touch panel and a method of manufacturing the same, more specifically, to an electrode pattern of a touch panel and a method of manufacturing the same, which can be efficiently produced with a low cost.

### BACKGROUND ART

A touch panel has been widely used in electrical apparatuses such as personal digital assistants, notebook computers, OA apparatuses or car navigation systems in order to provide an input means (i.e. pointing device) into their display devices. A resistive-based touch panel, an electronic inductive type touch panel, an optical touch panel, and a capacitive type touch panel have been known as representative touch panels.

In generally, a capacitive type touch panel is divided into an analogue type touch panel and a digital type touch panel.

In the analogue type touch panel, a sensor electrode is an electrode in a sheet shape, so no pattern is required in a sensing operation area. On the contrary, for the digital type touch panel, an electrode pattern for a sensor is required in a sensing operation area. In this digital type, the capacitive touch panel adopts a change in capacitance generated between the human body's electrostatics and a transparent electrode in order to induce basic currents which enable a position of a touch to be confirmed. In order to detect a position where the human body, for example, the fingers or a stylus, comes into contact with a touch panel, various capacitive touch panel technologies have been developed.

For one example, U.S. Pat. No. 6,970,160 discloses a lattice touch-sensing system for detecting a position of a touch on a touch-sensitive surface. The lattice touch-sensing system may include two capacitive sensing layers, separated by an insulating material, where each layer consists of substantially parallel conducing elements, and the conducting elements of the two sensing layers are substantially orthogonal to each other. Each element may comprise a series of diamond shaped patches that are connected together with narrow conductive rectangular strips. Each conducting element of a given sensing layer is electrically connected at one or both ends to a lead line of a corresponding set of lead lines. A control circuit may also be included to provide an excitation signal to both sets of conducting elements through the corresponding sets of lead lines, to receive sensing signals generated by sensor elements when a touch on the surface occurs, and to determine a position of the touch based on the position of the affected bars in each layer.

The aforesaid prior arts are mainly composed of constituent elements including two capacitive sensing layers. The two capacitive sensing layers are formed with a space filled with an insulating material therebetween to cause a capacitive effect between the layers.

FIG. 1 is a three-dimensional perspective view of an electrode pattern of a touch panel according to a conventional art. Referring to FIG. 1, the electrode pattern of a touch panel according to the conventional art includes a substrate 110, and a first-axis conductive pattern 120 and a second-axis conductive pattern 130 which are formed on the substrate. More specifically, the first-axis conductive pattern 120 is composed of first-axis conductive pattern cells 121, and a conductive pattern connecting unit 123 for connecting the same. Also, the second-axis conductive pattern 130 is composed of second-axis conductive transparent cells 131, and a conductive transparent pattern connecting unit 133 for connecting the same. Here, the conductive transparent pattern connecting unit 133 is formed on the first-axis pattern unit by interposing an insulating layer 50 therebetween.

FIG. 2 is a cross-sectional view showing a process for manufacturing the electrode pattern of the touch panel according to the conventional art.

Referring to FIG. 2, a PR 10 is formed in a remaining part excluding one part for forming the first conductive pattern on the substrate 110 (step a).

Next, a conductive transparent material coating layer 122 is formed by applying a conductive transparent material onto the PR 10 (step b), and the first-axis conductive pattern 120 is formed by removing the PR 10. However, this cross-sectional view shows that the first-axis conductive pattern connecting unit 123 is formed (step c).

Furthermore, as illustrated, a PR 20 is formed (step d), an insulating material coating layer 30 is formed by applying an insulating material thereon (step e), and thereafter an insulating layer 140 is formed by removing the PR 20 (step f).

Next, a PR 40 is formed in a remaining part excluding one part forming the second-axis conductive pattern from an upper surface of the substrate 110 (step g), a conductive transparent material coating layer 132 is formed by applying a conductive transparent material thereon (step h), and thereafter the second-axis conductive pattern 130 is formed by removing the PR 40 (step i).

FIG. 3 is a top view relating to the electrode pattern of the touch panel manufactured by the process of FIG. 2.

Referring to FIG. 3, the second conductive pattern 130 is connected by the conductive transparent material without a separate bridge electrode. The second conductive pattern 130 is configured such that the second conductive pattern cells 131, and the second conductive pattern connecting unit 133 for connecting the same 133 are integrally formed.

However, according to the conventional art, to form the second conductive pattern 130, the conductive transparent material coating layer 132 is formed by applying the conductive transparent material thereto at a time, so it was problematic that effectiveness in process reduces and a production cost increases.

### DISCLOSURE OF INVENTION

### Technical Problem

Accordingly, the present invention has been made keeping in mind the above problems occurring in the related art. An aspect of the present invention provides an electrode pattern of a touch panel and a method of manufacturing the same, which enables an electrode pattern to be efficiently formed when conductive patterns (Rx, Tx) are formed on one substrate, and enables the first conductive pattern Rx and the second conductive pattern Tx to be all formed on one substrate with a small cost while enabling a thickness of the touch panel to be reduced and transmission to be improved.

### Solution to Problem

According to an aspect of the present invention, there is provided a method of manufacturing an electrode pattern of a touch panel, including: forming first conductive pattern cells, which are directly connected to each other, on a substrate in a first axis direction; forming second conductive pattern cells between the first conductive pattern cells to be spaced apart from each other in a second axis direction which crosses a first axis direction; forming an insulating layer including a hole on the first conductive pattern cells and the second conductive pattern cells; forming a bridge electrode for connecting a pair of the second conductive pattern cells, which are adjacent to each other among the second conductive pattern cells, to each other and fills the hole with a conductive material.

According to another aspect of the present invention, there is provided an electrode pattern of a touch panel, including: first conductive pattern cells which are directly connected to each other in a first axis direction; second conductive pattern cells which are formed between the first conductive pattern cells to be spaced apart from each other in a second axis direction which crosses the first axis direction; an insulating layer which includes a hole and is formed on the first conductive pattern cells and the second conductive pattern cells; and a bridge electrode which is formed so that a pair of second conductive pattern cells, which are adjacent to each other among the second conductive pattern cells, are connected to each other, and fills the hole with a conductive material.

### Advantageous Effects of Invention

According to the present invention, as the conductive patterns (Rx, Tx) are all formed on one substrate, the electrode pattern can be efficiently formed compared to the conventional art, so that the touch panel, which has a reduced thickness and improved transmission, and in which the first conductive pattern Rx and the second conductive pattern Tx are all formed on one substrate, can be formed at a low cost.

### BRIEF DESCRIPTION OF DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a three-dimensional perspective view showing an electrode pattern of a touch panel according to a conventional art.

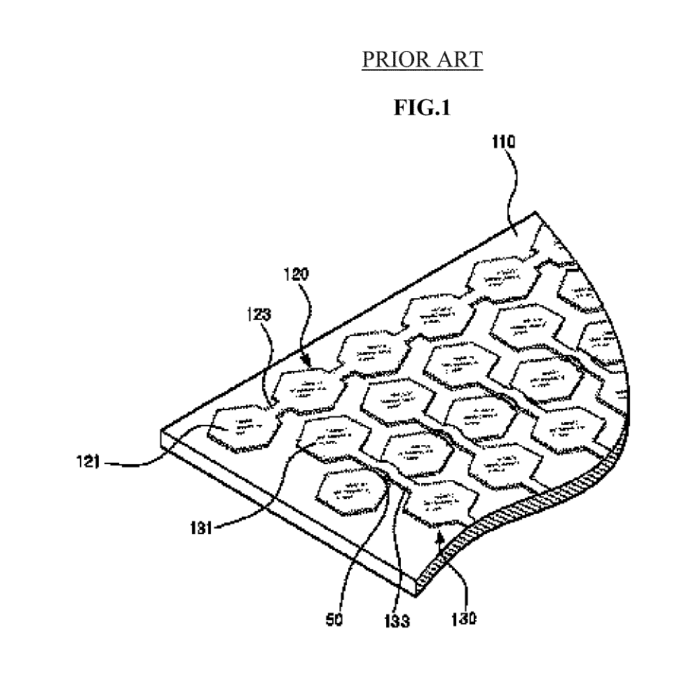

FIG. 2 is a cross-sectional view showing a process for manufacturing the electrode pattern of the touch panel according to the conventional art of FIG. 2.

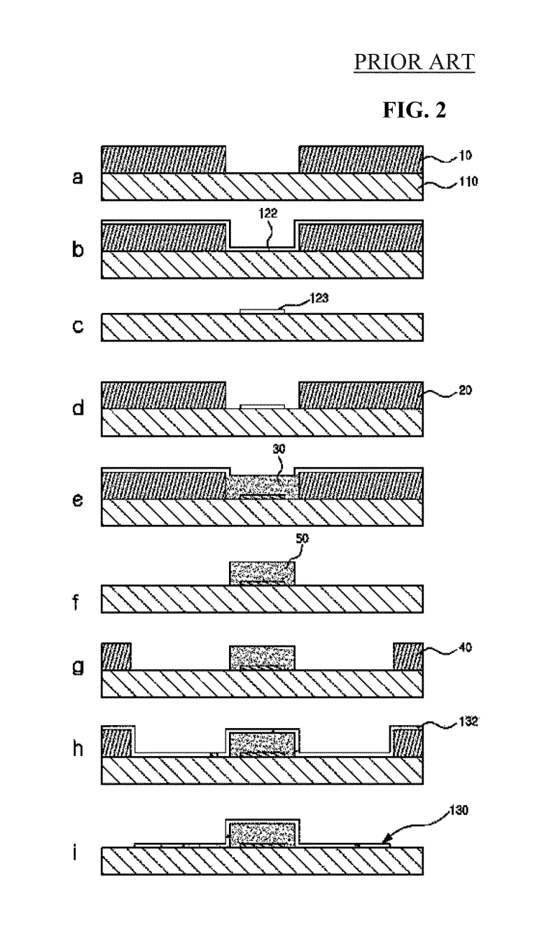

FIG. 3 is a top view showing the electrode pattern of the touch panel according to the conventional art.

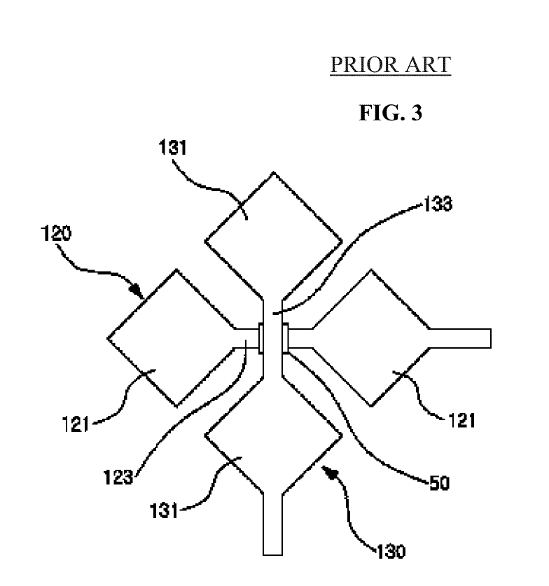

FIG. 4 and FIG. 5 are views illustrating an electrode pattern of a touch panel according to one exemplary embodiment of the present invention.

FIG. 6 is a cross-sectional view showing a process for manufacturing the electrode pattern of the touch panel according to the one embodiment of the present invention.

FIG. 7 is a view illustrating an electrode pattern before forming a bridge electrode of the electrode pattern of the touch panel according to the one exemplary embodiment.

FIG. 8 is a view illustrating an electrode pattern after forming a bridge electrode of the electrode pattern of the touch panel according to the one exemplary embodiment.

### MODE FOR THE INVENTION

Hereinafter, preferred embodiments of the present invention will be described in detail with reference to the accompanying drawings. In the following description, it is to be noted that, when the functions of conventional elements and the detailed description of elements related with the present invention may make the gist of the present invention unclear, a detailed description of those elements will be omitted. Further, it should be understood that the shape and size of the elements shown in the drawings may be exaggeratedly drawn to provide an easily understood description of the structure of the present invention rather than reflecting the actual sizes of the corresponding elements.

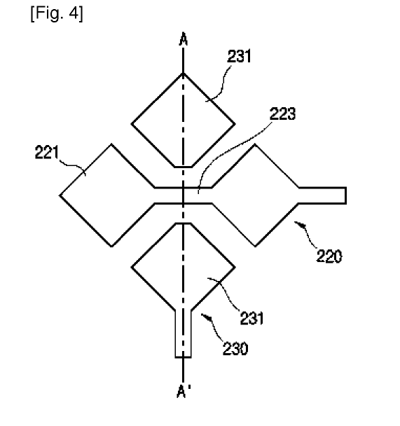

An electrode pattern of a touch panel according to one exemplary embodiment of the present invention will be explained with reference to FIG. 4 through FIG. 6.

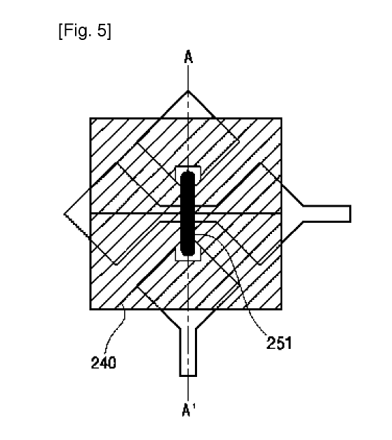

FIG. 4 and FIG. 5 are views illustrating an electrode pattern of a touch panel according to one exemplary embodiment of the present invention. FIG. 6 is a cross-sectional view showing a process for manufacturing the electrode pattern of the touch panel according to the one exemplary embodiment of the present invention.

FIG. 5 is that an insulating layer is disposed on an electrode pattern from FIG. FIG. 6 shows a cross-sectional view taken along A-A′from FIG. 4 and FIG. 5.

As illustrated in FIG. 4, a first conductive pattern 220 and a second conductive pattern 230 are formed a substrate.

First conductive pattern cells 221, which form the first conductive pattern 220, are directly connected to each other. Second conductive pattern cells 231, which form the second conductive pattern 230, are disposed between the first conductive pattern cells 221 to be spaced apart from each other.

Also, the first conductive pattern cells 221 are disposed in a first-axis direction, and the second conductive pattern cells 231 are formed in a second axis direction which crosses the first axis direction.

Meanwhile, the first conductive pattern cells 221 may be formed to be connected to each other by a conductive lead 223.

At this time, the first conductive pattern 220 or the second conductive pattern 230 are composed of at least any one of indium tin oxide (ITO), indium zinc oxide (IZO), zinc oxide (ZnO), a carbon nano tube (CNT), a conductive polymer and graphene.

Here, the first axis is formed to be right angles to the second axis. Thus, a disposition direction of the first conductive pattern cells 221 and a disposition direction of the second conductive pattern cells 231 cross at right angles. Like this, a cross section taken along A-A of FIG. 4 is the same as illustrated in a of FIG. 6.

Thereafter, an insulating layer 240 is disposed on the first conductive pattern cells 221 and the second conductive pattern cells 231. At this time, the insulating layer 240 may be formed using an off-set process or an ink-jet process.

A cross-sectional view showing that the insulating layer 240 is disposed on the first conductive pattern cells 221 and the second conductive patterns as above is illustrated in b of FIG. 6.

After the insulating layer 240 is disposed, a hole 241 is formed in the insulating layer 240.

The hole 241 is formed so that an upper surface of the second conductive pattern cells 231 is exposed, and is formed to be smaller than a width of the second conductive pattern cells 231. A cross-sectional view showing that the hole 241 is formed in the insulating layer 240 as described above is illustrated in c of FIG. 6. At this time, the hole 241 enables the second conductive pattern cells 231 to be electrically connected to each other later. The hole 241 is formed at positions corresponding to the second conductive pattern cells 231, respectively.

More specifically explaining it, when the hole 241 is formed in the insulating layer 240, the plurality of second conductive pattern cells 231 are formed on the insulating layer 240 corresponding to an end part closest between the plurality of second conductive pattern cells 231. By the hole 241 formed like this, the upper surface of the second conductive pattern cells 231 is exposed. At this time, the hole 241 is formed in a vertical direction to a surface of the second conductive pattern cells 231.

Next, a conductive material coating layer 250 is formed by applying a conductive material to the insulating layer 240 and the hole 241. As illustrated in d of FIG. 6, as the conductive material is applied onto the insulating layer 240 and the hole 241, the conductive material is injected into the hole 241, and the conductive material coating layer 250 is formed on the insulating layer 240 except for the hole 241.

Here, the conductive material is composed of any one of a carbon nano tube (CNT), an Ag nano wire, a Mo—Ag alloy, and a Ni—Cr alloy.

Next, as illustrated in e of FIG. 6, a bridge electrode 251 for connecting the plurality of second conductive pattern cells 231 to each other is formed by removing a part of the conductive material coating layer 250. More specifically explaining the bridge electrode formed as above, the bridge electrode is composed of a pillar part 252 connected to the second conductive pattern cells 231 by passing through the insulating layer 240 through the hole 241, and a body part 253 for connecting the pillar part 252. The pillar part 252 is formed in a vertical direction to a horizontal direction of the substrate 210. The body unit 253 is formed in an upper part of the insulating layer 240 of the substrate 210 and is formed in the horizontal direction to be the same as the horizontal direction of the substrate 210.

Thus, a pair of second conductive pattern cells, which are adjacent to each other among the second conductive pattern cells 231, are connected to each other by the bridge electrode 251

The bridge electrode 251 may be formed in a shape of a line electrode having a uniform thickness, and a thickness of the bridge electrode 251 may be variously modified in consideration an electric resistance property.

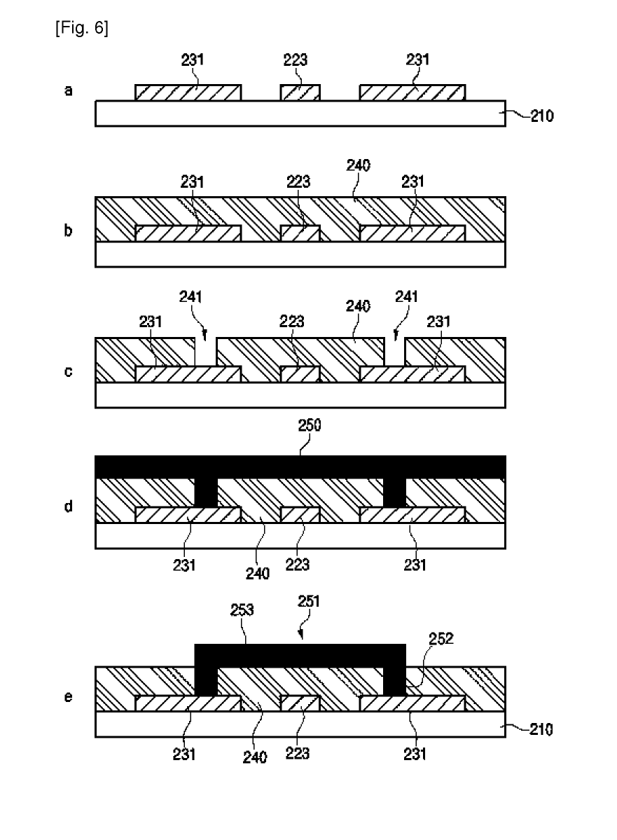

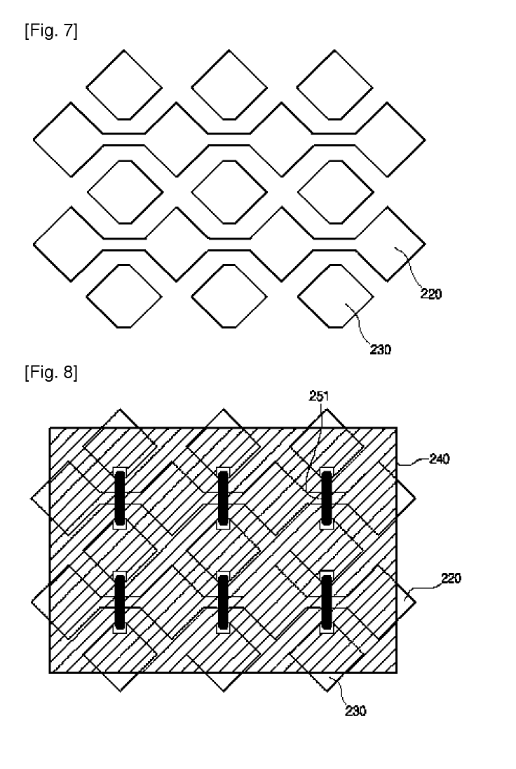

FIG. 7 and FIG. 8 are views the electrode pattern before and after forming the bridge electrode 151 of the electrode pattern of the touch panel according to the one exemplary embodiment of the present invention.

More specifically explaining it, FIG. 7 is a view illustrating more conductive patterns 220, 230 than the electrode pattern in the one exemplary embodiment of FIG. 4. FIG. 8 is a view illustrating that the insulating layer 240 is formed on the conductive patterns 220, 230 of FIG. 7, and the bridge electrode 251 is formed through the hole of the insulating layer.

As shown in FIG. 8, it can be seen that the bridge electrode 251 is a constituent element which electrically connects the second conductive patterns 230.

Thus, according to the present invention, the first conductive pattern Rx and the second conductive pattern Tx may be formed on one substrate.

That is, according to the present invention, the first conductive pattern Rx and the second conductive pattern Tx may be formed on one substrate, and thus no separate adhesive layer for bonding the conductive pattern layers to each other is also required.

Hereinafter, the configuration of the electrode pattern of the touch panel according to the one exemplary embodiment of the present invention will be explained with reference to FIG. 4, FIG. 5 and e of FIG. 6.

The electrode pattern of the touch panel according to the one exemplary embodiment of the present invention is configured such that the first conductive pattern 220 and the second conductive pattern 230 are formed on the substrate.

The first conductive pattern cells 221, which form the first conductive pattern 220, are formed to be directly connected to each other. The second conductive pattern cells 231, which form the second conductive pattern 230, are disposed between the first conductive pattern cells 221 to be spaced apart from each other.

Also, the first conductive pattern cells 221 are disposed in the first-axis direction, and the second conductive pattern cells 231 are formed in the second-axis direction which crosses the first-axis direction.

Meanwhile, the first conductive pattern cells 221 may be formed to be connected to each other by the conductive lead 223.

At this time, the first conductive pattern cells 221 and the second conductive pattern cells 231 are composed of at least any one of indium tin oxide (ITO), indium zinc oxide (IZO), zinc oxide (ZnO), a carbon nano tube (CNT), a conductive polymer and graphene.

The insulating layer 240 is formed on the first conductive pattern cells 221 or the second conductive pattern cells 231 formed as aforesaid.

The hole is formed on the insulating layer 240. As illustrated in FIG. 5, the hole formed on the insulating layer 240 is formed at a position corresponding to a end part closest between the plurality of second conductive pattern cells.

At this time, the hole generated in the insulating layer 240 is formed in the vertical direction to the surface of the second conductive pattern cells, and the upper surface of the second conductive pattern cells 231 is exposed by the hole. The hole is formed to be smaller than a width of the second conductive pattern cells 231.

The bridge electrode 251 for electrically connecting the second conductive pattern cells to each other is formed in the hole of the insulating layer 240.

The bridge electrode 251 is composed of at least one of a carbon nano tube (CNT), an Ag nano wire, a Mo—Ag alloy, and a Ni—Cr alloy.

The bridge electrode 251 is formed in a shape of the line electrode having a uniform thickness. The thickness of the bridge electrode 251 may be variously modified in consideration of an electric resistance property.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

1-19. (canceled)

20. A touch panel, comprising:
conductive pattern cells on a substrate;
an insulating layer on the conductive pattern cells and including holes; and
bridge electrodes in the holes and on the insulating layer,
wherein each bridge electrode connects, via the holes, only a pair of the conductive pattern cells adjacent to each other.

21. The touch panel of claim 20, wherein the conductive pattern cells comprise first conductive pattern cells arranged on the substrate in the direction of a first axis and electrically connected to each other in the direction of the first axis.

22. The touch panel of claim 21, wherein each first conductive pattern cell is connected to an adjacent first conductive pattern cell by a conductive lead.

23. The touch panel of claim 22, wherein the conductive pattern cells comprise second conductive pattern cells arranged on the substrate in the direction of a second axis which crosses the first axis.

24. The touch panel of claim 23, wherein the first axis and the second axis cross at a right angle to each other.

25. The touch panel of claim 24, wherein a surface of each first conductive pattern cell and each second conductive pattern cell comes into direct contact with the substrate.

26. The touch panel of claim 23, wherein the bridge electrodes wherein each bridge electrode connects only a pair of the second conductive pattern cells adjacent to each other.

27. The touch panel of claim 26, wherein the bridge electrodes comprise line electrodes connecting adjacent holes.

28. The touch panel of claim 27, wherein the line electrodes are on an upper surface of the insulating layer.

29. The touch panel of claim 27, wherein the line electrodes have a uniform thickness.

30. The touch panel of claim 27, wherein the line electrodes and the conductive leads overlap each other.

31. The touch panel of claim 30, wherein the line electrodes and the conductive leads cross at right angles to each other.

32. The touch panel of claim 23, wherein the holes are completely filled with the bridge electrodes.

33. The touch panel of claim 32, wherein each pair of connected second conductive pattern electrodes comprises a first adjacent second conductive pattern electrode and a second adjacent second conductive pattern electrode, and
wherein the first adjacent second conductive pattern cell is connected to the second adjacent second conductive pattern cell via a bridge electrode in the hole on the first adjacent second conductive pattern cell that is closest to the second adjacent second conductive pattern cell and in the hole on the second adjacent second conductive pattern cell that is closest to the first adjacent second conductive pattern cell.

34. The touch panel of claim 32, wherein the holes formed in the insulating layer are formed in a direction perpendicular to upper surfaces of the second conductive pattern cells.

35. The touch panel of claim 20, wherein the conductive pattern cells are interposed between the insulating layer and the substrate.

36. The touch panel of claim 20, wherein the insulating layer is interposed between the bridge electrodes and the substrate.

37. The touch panel of claim 20, wherein a single row of conductive pattern cells is connected by a plurality of bridge electrodes physically separated from each other.

38. The touch panel of claim 20, wherein the bridge electrodes are formed of any one of indium tin oxide (ITO), a carbon nano tube (CNT), an Ag nano wire, and a conductive polymer.

39. The touch panel of claim 33, wherein the first adjacent second conductive pattern cell is connected to the second adjacent second conductive pattern cell via a bridge electrode in a hole on an outer portion of the first adjacent second conductive pattern cell that is closest to the second adjacent second conductive pattern cell and in a hole on an outer portion of the second adjacent second conductive pattern cell that is closest to the first adjacent second conductive pattern cell.
